(19) United States
(12) Patent Application Publication
(10) Pub. No.: US 2025/0354939 A1
(43) Pub. Date: Nov. 20, 2025

(54) MULTI-AZIMUTH ILLUMINATION AND IMAGING INSPECTION SYSTEM AND METHOD

(71) Applicant: KLA Corporation, Milpitas, CA (US)

(72) Inventors: Bret Whiteside, Gilroy, CA (US); Chongyuan Huang, Fremont, CA (US); Zhiwei Xu, Sunnyvale, CA (US); Guan Gui, San Mateo, CA (US); Guoheng Zhao, Palo Alto, CA (US)

(21) Appl. No.: 18/986,066

(22) Filed: Dec. 18, 2024

Related U.S. Application Data
(60) Provisional application No. 63/648,688, filed on May 17, 2024.

(51) Int. Cl. G01N 21/88

(52) U.S. Cl. CPC G01N 21/8806; G01N 21/8851; G01N 2021/8841; G01N 2201/0635; G01N 2201/0638; G01N 2201/1035

(57) ABSTRACT

An inspection system and method are disclosed. The inspection system may include a controller configured to be communicatively coupled to an optical sub-system. The controller may include one or more processors configured to execute program instructions to cause the one or more processors to direct a stage to perform a first scanning of a sample using a first configuration of a beam-shaping channel, where the first configuration controls an orientation of a beam profile of an illumination beam as projected onto the sample; receive first scan data associated with the first scanning; direct the stage to perform a second scanning using a second configuration of the beam-shaping channel; receive second scan data associated with the second scanning; and identify one or more defects on the sample based on scan data from at least the first and second scans. The stage may include an X-Y θ stage.

### CROSS-REFERENCE TO RELATED APPLICATION

The present application claims the benefit under 35 U.S.C. § 119(e) of U.S. Provisional Application Ser. No. 63/648,688, filed May 17, 2024, which is incorporated herein by reference in the entirety.

### TECHNICAL FIELD

The present disclosure relates generally to semiconductor characterization devices and, more particularly, to systems and methods configured to scan semiconductor devices using a variety of azimuthal angles.

### BACKGROUND

An inspection tool typically includes at least a light source, a beam shaper, and a translation-rotation stage to move the wafer sample. The beam from the light source is sent through the beam shaper and then incident onto the wafer from an oblique/non-perpendicular angle. The illumination beam on the wafer is typically shaped into a long and narrow rectangular spot with a flattop intensity distribution to maximize efficiencies of energy delivery and signal collection. To reduce noise of the measurements and achieve high fidelity results, every area on the wafer is typically illuminated by multiple independent beams coming from different azimuthal angles. The more illumination angles used, the more noise can be reduced, and the better the results will be. The azimuthal angle may be defined as the angle the illumination beam is incident on the sample relative to a scanning direction when viewed from above the sample.

In order to provide the multiple independent beams from different azimuthal angles, separate and independent beam-shaping optics are used for each beam.

There may exist a desire for a system and method that improves upon the conventional methodologies of inspecting a sample using multiple azimuthal angles.

### SUMMARY

An inspection system is disclosed in accordance with one or more illustrative embodiments of the present disclosure. In one illustrative embodiment, the inspection system may include a controller communicatively coupled to an optical sub-system. In another illustrative embodiment, the controller may include one or more processors configured to execute program instructions. In another illustrative embodiment, the program instructions may cause the one or more processors to generate control signals for a beam-shaping channel to configure the beam-shaping channel to provide one or more selected orientations of a beam profile. In another illustrative embodiment, the program instructions may cause the one or more processors to direct a stage to perform one or more scans, including a first scanning of a sample using a first configuration of the beam-shaping channel. In another illustrative embodiment, the first configuration of the beam-shaping channel may control an orientation of the beam profile of an illumination beam as projected onto the sample. In another illustrative embodiment, the program instructions may cause the one or more processors to receive first scan data associated with the first scanning of the sample and identify one or more defects on the sample based on scan data associated with the one or more scans.

In a further aspect, the first configuration of the beam-shaping channel may include a first orientation of a diffractive optical element of the beam-shaping channel. In another aspect, the diffractive optical element may be configured to be rotated around an axis of the illumination beam. In another aspect, the controller may be further configured to direct a rotation or translation of the diffractive optical element from the first orientation to a second orientation. In another aspect, the diffractive optical element may include a Fresnel zone plate (FZP) offset from the axis of the illumination beam. In another aspect, the beam-shaping channel may include a holographic optical element (HOE) and an aspherical lens.

In another illustrative embodiment, the controller may be further configured to direct at least one of a rotation or translation of one or more cylindrical lenses of the beam-shaping channel. In another illustrative embodiment, the inspection system may include a collection sub-system. In another illustrative embodiment, the collection sub-system may include a detector and a detection plane rotator. In another illustrative embodiment, the detection plane rotator may perform a rotation of collectable light as detected by the detector. In another illustrative embodiment, the rotation of the collectable light may include at least one of a rotation of an orientation of the collectable light incident on the detector or an orientation of the detector.

In a further aspect, the controller may be configured to direct the detection plane rotator to perform the rotation of the collectable light. In another aspect, the detection plane rotator may include at least one of a Dove Prism, a K-mirror, or a Schmidt-Pechan Prism. In another illustrative embodiment, the beam profile may include a flat top profile such that an intensity distribution is uniform. In another illustrative embodiment, the beam profile may include a spot array. In another illustrative embodiment, the spot array may include a series of ellipses sequentially aligned in a row along a direction, where a major axis of each ellipse is angled at a non-zero angle with respect to the direction.

In another illustrative embodiment, the scan data from the one or more scans may include a second scan data associated with a second scanning of the sample. In another illustrative embodiment, the scan data from the one or more scans may include a third scan data associated with a third scanning of the sample. In another illustrative embodiment, the stage may include an X-Y θ stage configured to translate the sample in two orthogonal directions and rotate the sample. In another illustrative embodiment, the controller may be further configured to direct the X-Y θ stage to at least translate the sample between the first scanning and a second scanning. In another illustrative embodiment, the controller may be further configured to direct the X-Y θ stage to simultaneously rotate the sample and translate the sample along two directions during the first scanning, where the first scanning is configured along a spiral scan pattern.

An inspection system is disclosed in accordance with one or more illustrative embodiments of the present disclosure. In one illustrative embodiment, the inspection system may include a stage configured to translate and rotate a sample. In another illustrative embodiment, the inspection system may include an optical sub-system. In another illustrative embodiment, the optical sub-system may include an illumination sub-system with a beam-shaping channel, where a configuration of the beam-shaping channel controls an orientation of a beam profile of an illumination beam as projected onto the sample. In another illustrative embodiment, the optical sub-system may include a collection sub-system with a detector configured to image the sample. In another illustrative embodiment, the inspection system may include a controller communicatively coupled to the optical sub-system.

In another illustrative embodiment, the controller may include one or more processors configured to execute program instructions to receive first scan data associated with a first orientation of the beam profile of the illumination beam and a first scanning of the sample, receive second scan data associated with a second orientation of the beam profile of the illumination beam and a second scanning of the sample, and identify one or more defects on the sample based on scan data from at least the first and second scans. In another illustrative embodiment, the first configuration of the beam-shaping channel may include a first orientation of a diffractive optical element of the beam-shaping channel, where the diffractive optical element is configured to be rotated around an axis of the illumination beam. In another illustrative embodiment, the controller may be configured to direct a rotation of the diffractive optical element around the axis of the illumination beam from the first orientation to a second orientation.

In another illustrative embodiment, the controller may be configured to direct a translation of the diffractive optical element from the first orientation to the second orientation. In another illustrative embodiment, the diffractive optical element may include a Fresnel zone plate (FZP) offset from the axis of the illumination beam. In another illustrative embodiment, the beam-shaping channel may include a holographic optical element (HOE) and an aspherical lens. In another illustrative embodiment, the collection sub-system may include a detection plane rotator configured to perform a rotation of collectable light as detected by the detector, where the rotation of the collectable light may include at least one of a rotation of an orientation of the collectable light incident on the detector or an orientation of the detector.

In another illustrative embodiment, the controller may be configured to direct the detection plane rotator to perform the rotation of the collectable light. In another illustrative embodiment, the detection plane rotator may include at least one of a Dove Prism, a K-mirror, or a Schmidt-Pechan Prism. In another illustrative embodiment, the beam profile may include a rectangular shape having a flat top profile. In another illustrative embodiment, the beam profile may include a spot array, where the spot array may include a series of ellipses sequentially aligned in a row along a direction and where a major axis of each ellipse may be angled at a non-zero angle with respect to the direction.

In another illustrative embodiment, the scan data from the two or more scans may include a third scan data associated with a third scanning of the sample. In another illustrative embodiment, the scan data from the two or more scans may include a fourth scan data associated with a fourth scanning of the sample. In another illustrative embodiment, the stage may include an X-Y θ stage configured to translate the sample in two orthogonal directions and rotate the sample. In another illustrative embodiment, the controller may be configured to direct the X-Y θ stage to at least translate the sample between the first scanning and the second scanning. In another illustrative embodiment, the controller may be configured to direct the X-Y θ stage to simultaneously rotate the sample and translate the sample along two directions during the first scanning, where the first scanning may be configured along a spiral scan pattern.

A method for inspecting using a plurality of azimuthal angles is disclosed in accordance with one or more illustrative embodiments of the present disclosure. In one illustrative embodiment, the method may include performing a first scanning of a sample using a first configuration of a beam-shaping channel of an optical sub-system. In another illustrative embodiment, the first configuration may control an orientation of a beam profile of an illumination beam as projected onto the sample. In another illustrative embodiment, the method may include receiving first scan data associated with the first scanning. In another illustrative embodiment, the method may include performing a second scanning using a second configuration of the beam-shaping channel, corresponding to a second orientation of the beam profile. In another illustrative embodiment, the method may include receiving second scan data associated with the second scanning. In another illustrative embodiment, the method may include identifying one or more defects on the sample based on scan data from at least the first and second scans.

In a further aspect, the first configuration of the beam-shaping channel may include a first orientation of a diffractive optical element. In another aspect, the diffractive optical element may be configured to be rotated around an axis of the illumination beam. In another aspect, the method may include rotating the diffractive optical element from the first orientation to the second orientation. In another aspect, the scan data from the two or more scans may include a third scan data associated with a third scanning of the sample. In another aspect, the scan data may include a fourth scan data associated with a fourth scanning. In another aspect, the stage may include an X-Y θ stage configured to translate the sample in two orthogonal directions and rotate the sample. In another aspect, the method may include directing the X-Y θ stage to at least translate the sample between the first and second scanning. In another aspect, the method may include directing the X-Y θ stage to simultaneously rotate and translate the sample along two directions during the first scanning, where the first scanning is configured along a spiral scan pattern.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures.

FIG. 1 illustrates a conventional system for inspecting a sample using a plurality of beam-shaping channels.

FIG. 2 illustrates a block diagram of an inspection system for inspecting a sample using a plurality of azimuthal angles and a single beam-shaping channel, in accordance with one or more embodiments of the present disclosure.

FIG. 3A illustrates a side view of the beam-shaping channel scanning the sample, in accordance with one or more embodiments of the present disclosure.

FIG. 3B illustrates a top view of the single beam-shaping channel and two beam profile orientations, in accordance with one or more embodiments of the present disclosure.

FIG. 3C illustrates a top view of the single beam-shaping channel and three beam profile orientations, in accordance with one or more embodiments of the present disclosure.

FIG. 3D illustrates a top view of the single beam-shaping channel and four beam profile orientations, in accordance with one or more embodiments of the present disclosure.

FIGS. 4A through 4C illustrate views of a single beam-shaping channel scanning a sample at a variety of azimuthal angles based on a stage rotation direction and translation direction of the stage, in accordance with one or more embodiments of the present disclosure.

FIG. 5 illustrates a top view of a single beam-shaping channel corresponding to a beam profile, in accordance with one or more embodiments of the present disclosure.

FIG. 6A illustrates a perspective view of a first scanning of a sample, in accordance with one or more embodiments of the present disclosure.

FIG. 6B illustrates a perspective view of a rotation, translation, and/or swapping of the diffractive optical element to a second configuration causing a corresponding rotation of a beam profile incident on the sample, in accordance with one or more embodiments of the present disclosure.

FIG. 6C illustrates a perspective view of a translation of the sample relative to the beam profile, in accordance with one or more embodiments of the present disclosure.

FIG. 6D illustrates a perspective view of a second scanning of the sample using the second orientation of the beam profile, in accordance with one or more embodiments of the present disclosure.

FIG. 7 illustrates a top view of various beam profile orientations and corresponding translated sample locations, in accordance with one or more embodiments of the present disclosure.

FIG. 8A illustrates a side view of a K-mirror detection plane rotator, in accordance with one or more embodiments of the present disclosure.

FIG. 8B illustrates a side view of the K-mirror detection plane rotator configured to perform a rotation of collectable light on the detector to match an orientation of the detector, in accordance with one or more embodiments of the present disclosure.

FIG. 9 illustrates a process flow diagram depicting a method for inspecting a sample using a plurality of azimuthal angles and a single beam-shaping channel, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

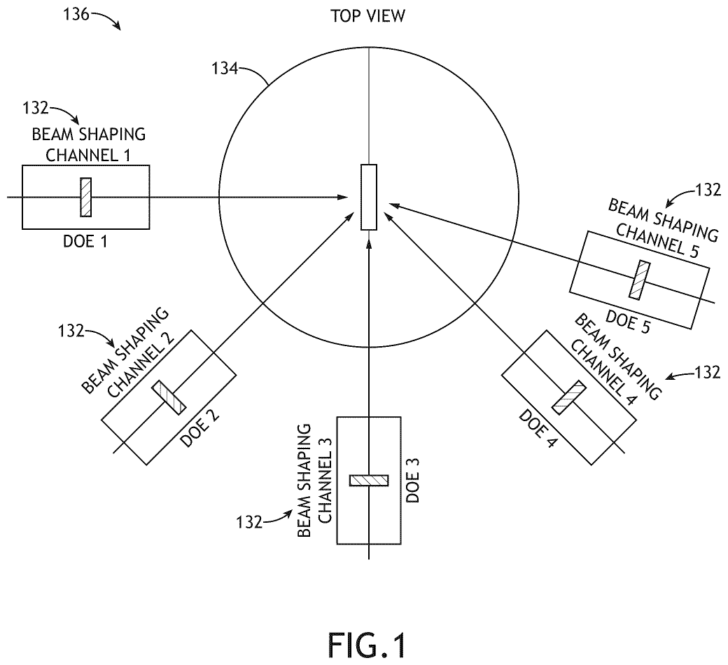

FIG. 1 illustrates a conventional system 136 for inspecting a sample 134 using a plurality of beam-shaping channels 132.

Current methodologies to achieve multiple azimuthally-angled illumination beams may use multiple illumination beams originating from separate beam-shaping channels 132. In each beam-shaping channel 132, a DOE may be fixed at a specific angle to shape the input beam into a long and narrow spot on the sample 134. An R-θ stage (not shown) may be used to rotate and linearly translate the sample 134, so the whole sample 134 may be scanned by the beam from each illumination angle.

Each beam-shaping channel 132 may require its own set of optical and mechanical components. Multiple sets of optical and mechanical components may be cost-prohibitive and impractical to provide at scale. Using multiple beam-shaping channels 132 may increase system complexity and size, leading to further technical issues. For example, multiple beam-shaping channels 132 may cause long-term stability issues, or lack of ease of assembly and service.

Embodiments of the present disclosure are directed to inspecting a sample with an illumination beam at multiple azimuthal angles by adjusting a single beam-shaping channel. In embodiments, rotating, translating, and/or swapping one or more elements of the beam-shaping channel corresponds to a rotation of a beam profile incident on the sample. For example, the beam profile may be rotated by rotating, translating, and/or swapping a diffractive optical element and/or other optics within the beam-shaping channel. In this way, the single beam-shaping channel may be used to achieve an infinite number of azimuthal angles without requiring multiple beam-shaping channels. The beam profile may be any beam profile described in the present disclosure or known in the art. For example, a narrow rectangular or ellipse beam profile may be used with a lengthwise dimension of the beam profile aligned perpendicular to a scan direction. When the beam profile orientation as projected onto the sample is rotated using the beam-shaping channel, then the scanning direction may be correspondingly adjusted to align with the rotated beam profile orientation.

Embodiments of the present disclosure illustrate a new architecture for generating multiple independent azimuthally-angled illumination beams by using different configurations (e.g., mechanical adjustments) to a beam-shaping channel. For example, the configurations may include different rotational and/or translated configurations of a diffractive optical element (DOE). For example, the configurations may include different rotational and/or translated configurations of any component of a beam-shaping channel such as adjustments to cylindrical lenses. By way of another example, any component may be swapped out for a different component associated with a different orientation of the beam profile. This architecture may greatly reduce the complexity and cost of a scanning functionality of a characterization system such as an inspection system.

U.S. Pat. No. 9,176,072, titled “DARK FIELD INSPECTION SYSTEM WITH RING ILLUMINATION”; U.S. Pat. No. 11,366,069, titled “SIMULTANEOUS MULT-DIRECTIONAL LASER WAFER INSPECTION”; are each incorporated herein by reference in the entirety.

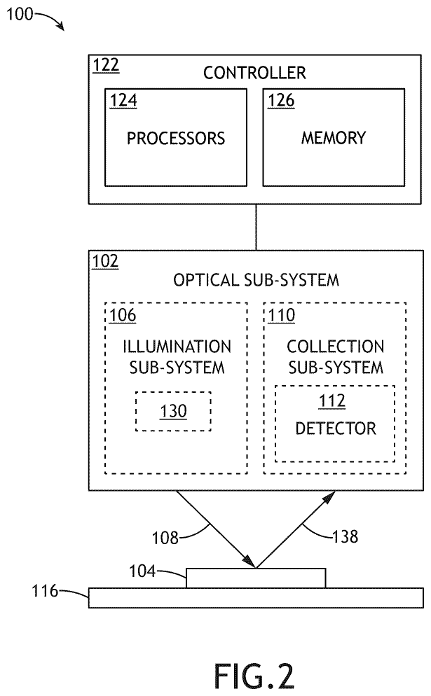

FIG. 2 illustrates a block diagram of an inspection system 100 for inspecting a sample 104 using a plurality of azimuthal angles and a single beam-shaping channel 130, in accordance with one or more embodiments of the present disclosure.

The inspection system 100 may be configured for inspecting any sample known in the art including, but not limited to, a semiconductor wafer, a reticle, or a flat panel display. In embodiments, the inspection system 100 includes an optical sub-system 102 to perform the inspection of the sample 104.

In embodiments, the optical sub-system 102 includes an illumination sub-system 106 and a collection sub-system 110. The collection sub-system 110 may include one or more detectors 112 configured to image the sample 104.

In embodiments, the illumination sub-system 106 includes a beam-shaping channel 130 configured to rotate and/or translate a beam profile of an illumination beam 108 projected onto the sample 104. The illumination sub-system 106 may be configured to generate broadband light.

In embodiments, light reflected and/or scattered from the sample 104 and detectable by the detector 112 may be referred to as collectable light 138. The collectable light 138 is received by the one or more detectors 112.

Scan data received by the inspection system 100 may include any type of image known in the art such as, but not limited to, a brightfield image, a darkfield image, a phase-contrast image, or the like. For instance, the collection sub-system 110 may be configured to collect reflected light and/or detect scattered light. In a dark-field imaging mode, the scattered light is detected. In a bright-field imaging mode, the reflected light is collected. Further, images may be stitched together to form a composite image of the sample 104 or a portion thereof, although this is not intended as a limitation of the present disclosure.

In embodiments, the inspection system 100 may be configured for both dark-field and bright-field imaging, or one or the other. For example, the inspection system 100 may include one or more first detectors 112 configured for a dark-field imaging mode and one or more second detectors 112 configured for a bright-field imaging mode. For instance, the inspection system 100 may be configured to use the dark-field imaging mode at a different time, or at the same time, as the bright-field imaging mode.

In embodiments, the inspection system 100 includes a controller 122. In embodiments, the controller 122 includes one or more processors 124 and a memory device 126, or memory. For example, the one or more processors 124 may be configured to execute a set of program instructions maintained in the memory device 126. The controller may be communicatively coupled to the optical sub-system 102.

The inspection system 100 may include a stage 116 configured to translate and/or rotate the sample 104. The stage 116 may include any stage assembly known in the art of inspection systems including, but not limited to, an X-Y stage, an R-θ stage, an X-Y θ stage, and the like. For example, the stage 116 may include an R-θ stage configured to translate and rotate the sample 104.

By way of another example, the stage 116 may include an X-Y θ stage configured to translate the sample 104 in two directions (e.g., X and Y direction) and rotate the sample 104. Typically, in conventional inspection systems, the stage is an X-Y stage, or an R-θ stage. It is contemplated herein that an X-Y θ stage may be used for inspecting the sample 104 using a variety of azimuthal angles.

The stage 116 may include a linear stage configured to translate the sample 104 along a first and a second direction, such as an X and Y direction. During a scan, the stage 116 may be used to rotate the sample 104. Between scans, the stage 116 may be used to translate the sample 104 relative to the beam profile as projected onto the sample 104.

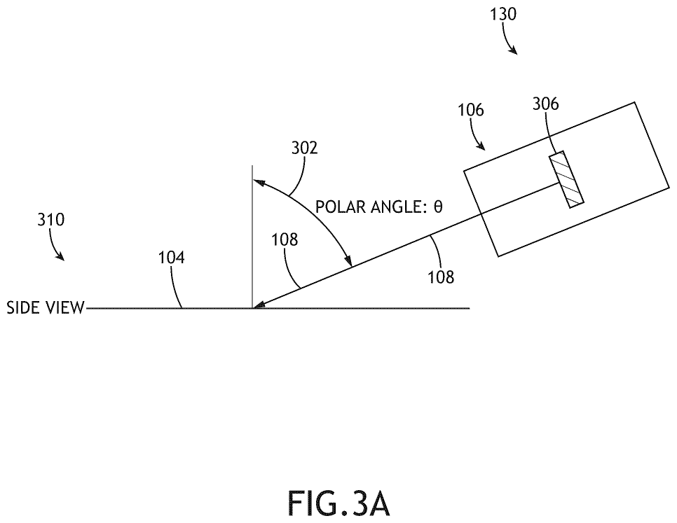

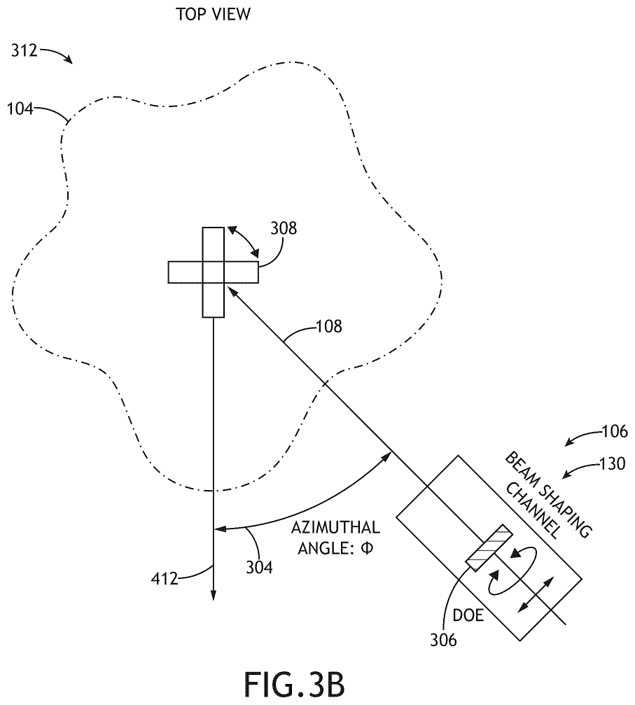

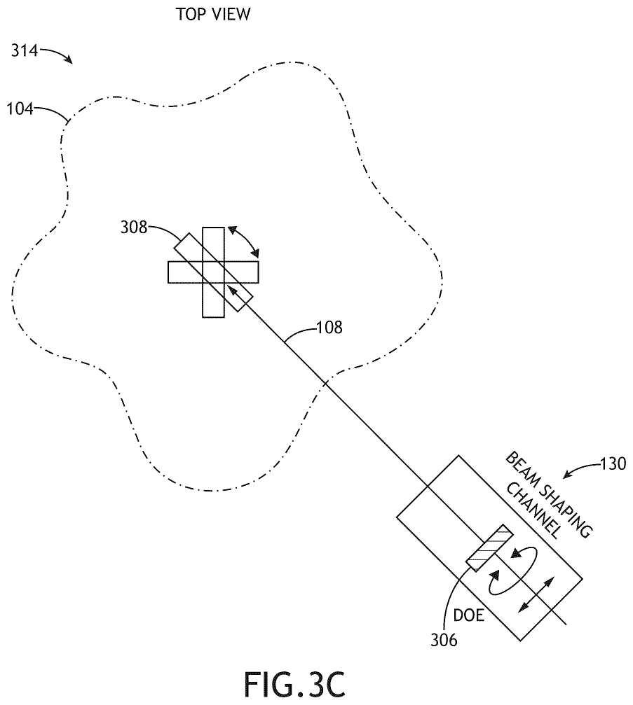

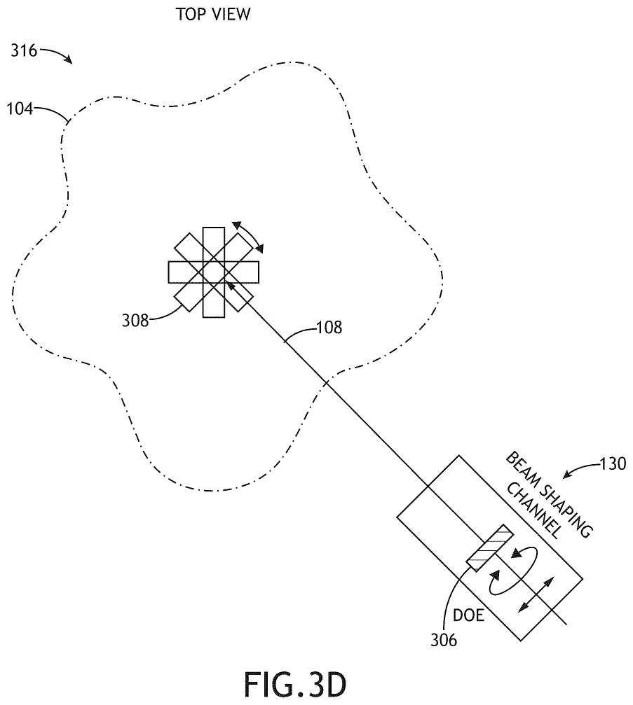

FIG. 3A illustrates a side view 310 of the beam-shaping channel 130 scanning the sample 104, and FIGS. 3B through 3D illustrate top views 312, 314, 316 of generating multiple independent azimuthally-angled illumination beams 108 from only one beam-shaping channel 130, in accordance with one or more embodiments of the present disclosure.

Note that the sample 104 shown in FIGS. 3A through 3D has the beam profile 308 in the center, but FIGS. 3A through 3D are not meant to illustrate the entire sample 104. Rather, FIGS. 3A through 3D illustrate a portion of the sample 104, such as a zoomed-in portion.

The polar angle 302 is defined as the angle that the illumination beam 108 is projected onto the sample 104 relative to a direction that is normal/perpendicular to the sample 104. For example, the direction that is normal may be perpendicular to a top, exterior, outward-facing surface of the sample 104 that is being inspected. In embodiments, the polar angle 302 may be between 0 and 90 degrees, such as a non-zero angle less than 90 degrees. For example, the polar angle 302 may be between 10 and 80 degrees.

FIG. 3B illustrates a top view 312 of the single beam-shaping channel 130 and two beam profile 308 orientations, in accordance with one or more embodiments of the present disclosure. The multiple beam profile 308 orientations are shown simultaneously for clarity and conciseness only. In practice, each of the beam profile 308 orientations may be used in separate scanning steps with translations of the sample 104 between each scan.

The azimuthal angle 304, is defined as the angle that the illumination beam 108 is projected onto the sample 104 with respect to a scan direction corresponding to the orientation of the beam profile 308. In embodiments, the azimuthal angle 304 is measured from the top-down view, between the illumination beam 108 as projected onto the sample 104 and the scan direction. For example, the azimuthal angle 304 which corresponds to the horizontal orientation of the beam profile 308 is shown between the scan direction 412 and the illumination beam 108 from a top-down view. The scan direction and azimuthal angle for the vertical beam profile 308 is not shown for clarity, but would extend towards the right side of FIG. 3B.

In embodiments, two scans may be directed to be performed. For example, the two scans may correspond to a first and second configuration of the beam-shaping channel 130 controlling, respectively, a first and second orientation of the beam profile 308. For instance, as shown, the first and second orientation of the beam profile 308 may include a first orientation orthogonal to a second orientation. For example, the first orientation may be horizontal and the second orientation may be vertical.

FIG. 3C illustrates a top view 314 of the single beam-shaping channel 130 and three beam profile 308 orientations, in accordance with one or more embodiments of the present disclosure.

In embodiments, three scans may be directed to be performed. For example, in addition to the first and second beam profile 308 orientations, a third orientation of the beam profile 308 may be controlled. For instance, the third orientation may be a diagonal orientation, such as an orientation at a negative 45-degree angle.

FIG. 3D illustrates a top view 316 of the single beam-shaping channel 130 and four beam profile 308 orientations, in accordance with one or more embodiments of the present disclosure.

In embodiments, four scans may be directed to be performed. For instance, a fourth orientation may be a diagonal orientation, such as an orientation at a positive 45-degree angle.

In embodiments, the beam profile 308 may include any beam profile shape and beam intensity profile known in the art of inspection systems. For example, the beam profile 308 may include a rectangular shape. For instance, the rectangular shape may have a flat top profile such that the intensity distribution across the illumination beam is uniform. However, note that rectangular shapes do not necessarily require flat top profiles. A flat top profile is different than a Gaussian profile. In a Gaussian profile, the intensity peaks in the center and falls off towards the edges. By way of another example, the shape of the beam profile 308 may include an ellipse, such as a flat top elliptical profile. By way of another example, the beam profile 308 may include the Gaussian profile.

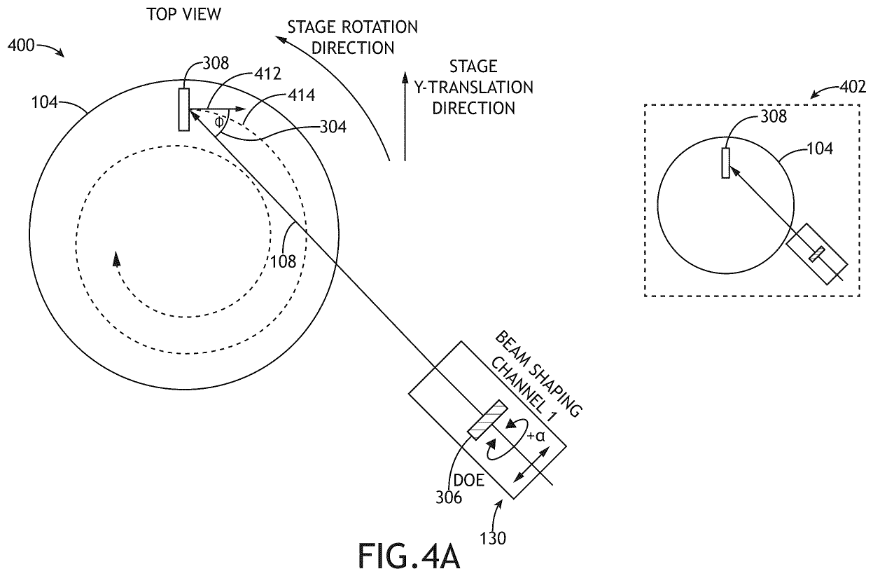

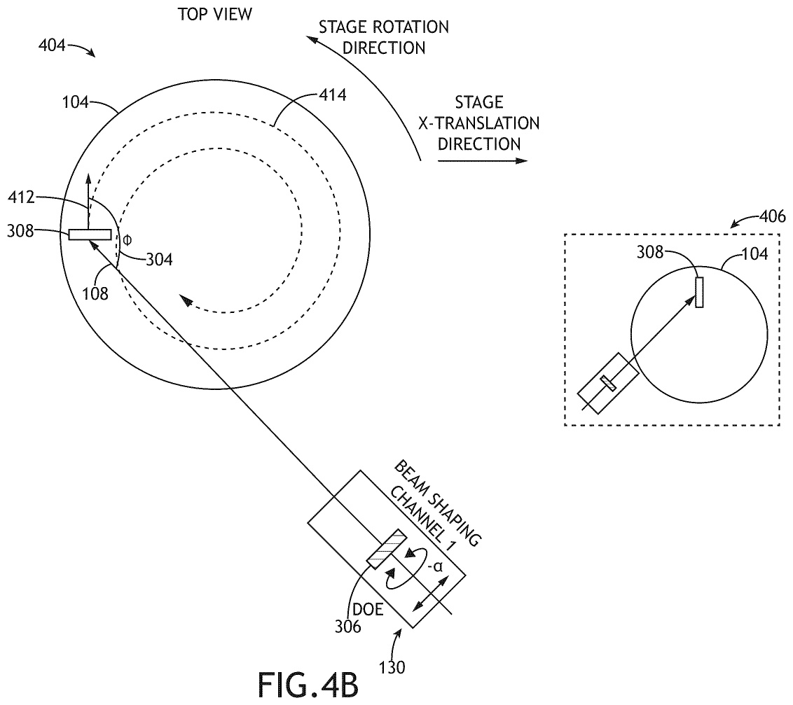

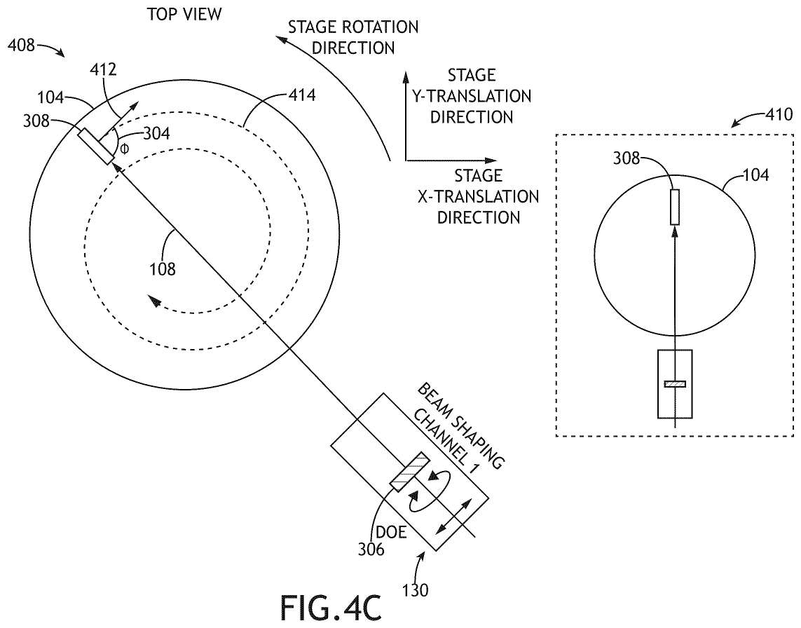

FIGS. 4A through 4C illustrate views 400, 402, 404, 406, 408, 410 of the beam-shaping channel 130 scanning the sample 104 at a variety of azimuthal angles 304 based on a stage rotation direction and translation direction of the stage 116 and the sample 104 coupled to the stage 116, in accordance with one or more embodiments of the present disclosure. When views 402, 406, 410 are adjusted so that the different orientations of beam profiles 308 are aligned in the same direction, the difference in azimuthal angles 304 is apparent.

In embodiments, the stage 116 may be directed to translate and/or rotate the sample 104 for one or more reasons. For example, the sample 104 may be rotated for a circle scan. For example, the sample 104 may be translated to position the beam profile 308 at or proximate to an edge of the sample 104 or a center of the sample 104.

In embodiments, the sample 104 may be scanned in any pattern known in the art of inspection systems and/or disclosed herein.

In FIG. 4A, a circular spiral scan path 414 is illustrated where the sample 104 is translated and rotated simultaneously. For example, a scan direction 412 of a scanning path 414 may be scanned in a spiral from the center to the edge of the sample 104 or from the edge to the center. The scan direction 412 is orthogonal to the long axis of the beam profile 308. In FIG. 4A the sample 104 is translated linearly in a Y-direction and rotated counterclockwise. In this case, the translation direction of the stage 116 follows the Y-direction, so the wider edge of the rectangle beam profile 308 can be used for scanning. However, note that the scan patterns described herein are for illustrative purposes only and are not meant to be limiting. For instance, the scan pattern may include a spiral scan pattern to and/or from an edge and a center of the sample 104. In addition, the scan pattern may be in either a clockwise or counterclockwise direction.

The beam-shaping channel 130 is fixed at a first azimuthal angle 304 (+ϕ), while the DOE 306 is set at a first DOE angle (+α). The first DOE angle (+α) of the DOE 306 controls the beam profile 308 angle of the illumination beam 108 to, in this case, be at a vertical orientation.

Between scans, although not shown, the sample 104 may be translated and/or rotated to align the beam profile 308 with the center or edge of the sample 104. After the alignment, the sample 104 may be ready for the next scan.

In FIG. 4B, during a second scanning, the sample 104 may start in a second location and be translated linearly in a X-direction and rotated counterclockwise. The sample 104 may alternatively be rotated clockwise. When the DOE 306 is rotated (e.g., counterclockwise) around the axis of the illumination beam 108 to a second DOE angle (−α), a new horizontal orientation of the beam profile 308 with the same beam profile can be produced as shown in view 404. If the stage 116 linearly translates the sample 104 along the X-axis during scanning, the whole sample 104 may be illuminated by the illumination beam 108 coming from a second azimuthal angle (−ϕ).

In FIG. 4C, during a third scanning, the sample 104 may start in a third location and be translated linearly in both the X-direction and the Y-direction, and rotated counterclockwise. The sample 104 may alternatively be rotated clockwise. In this case, the translation direction of the stage 116 follows a 45-degree angle relative to the X and Y direction, so the wider edge of the rectangle beam profile 308 can be used for scanning. When the DOE 306 is rotated clockwise back to 0 degrees (α=0) and translated for a certain distance, another orientation of the beam profile 308 with the same rectangular shape can be produced as shown in view 408. If the XY-Theta stage 116 linearly translates the sample 104 along the X and Y axes, the linear motion scan direction is the combination of X and Y direction. Similarly, the whole sample 104 may be characterized, but now using an azimuthal angle 304 of 0 degrees, or 90 degrees depending on how it is defined.

The secondary view 402 of FIG. 4A is simply a view of the same beam profile 308 when the perspective of the viewer is changed/rotated so that the beam profile 308 is vertical. In this case, the secondary view 402 is the same as view 400 because the beam profile 308 is already vertical in view 400 and so no alignment of the secondary view 402 is needed. The location of the beam-shaping channel 130 is in the same location (e.g., bottom right) in both views 400, 402. As the DOE angle (α) is changed to control the angle of the beam profile 308, then the location of the beam-shaping channel 130 relative to the vertical orientation of the beam profile 308 will change. As shown in secondary view 406 of FIG. 4B, when the perspective of the viewer is aligned with a vertical orientation of the beam profile 308, then the effective azimuthal angle of the beam-shaping channel 130 is apparent. Now the beam-shaping channel 130 is bottom left, rather than bottom right. Lastly, as shown in secondary view 410 of FIG. 4C, when the perspective of the viewer is aligned with a vertical orientation of the beam profile 308, the beam-shaping channel 130 is bottom centered, rather than bottom left or bottom right. In this manner, multiple effective azimuthal angles 304 may be effectuated by a single beam-shaping channel 130.

Although a translation direction of 45-degrees is used here, the translation direction of the stage 116 may be any angle, since the effective translation direction is a combination of any possible combination of speeds of translations in the X-direction and the Y-direction.

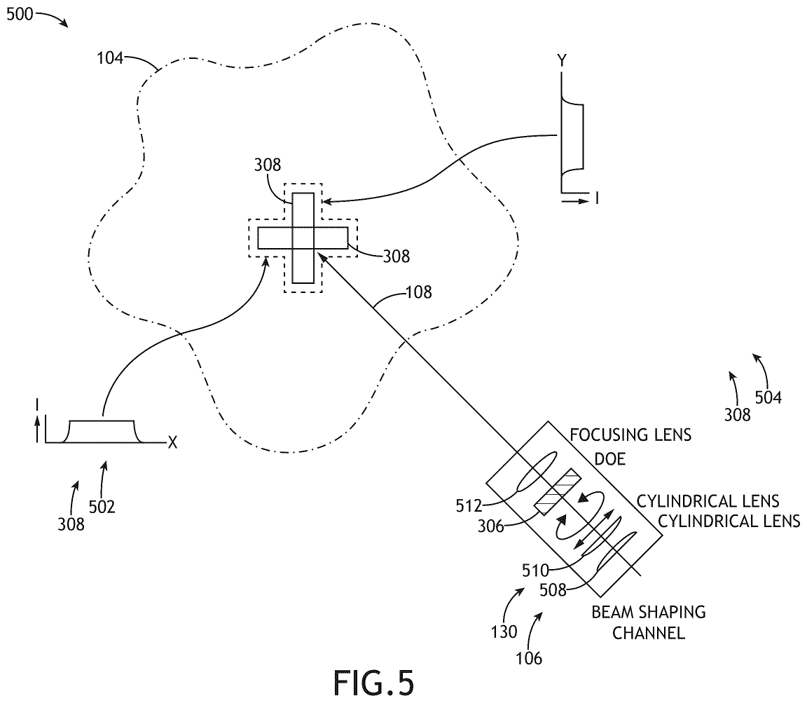

FIG. 5 illustrates a top view 500 of a single beam-shaping channel 130 corresponding to a beam profile 308, in accordance with one or more embodiments of the present disclosure.

Note that the sample 104 shown in FIG. 5 has the beam profiles 308 in the center, but FIG. 5 is not meant to illustrate the entire sample 104. Rather, FIG. 5 illustrates a portion of the sample 104, such as a zoomed-in portion.

As noted earlier, the beam profile 308 may include any beam profile shape and beam intensity profile known in the art of inspection systems. For example, as shown, a horizontal flat-top distribution 502 and a vertical flat-top distribution 504 may be used.

Various methodologies may be used for generating various beam profile shapes and beam intensity profiles.

For example, the beam profile 308 may include a spot array. The spot array may include a series of ellipses sequentially aligned in a row along a direction. A major axis of each ellipse may be angled at a non-zero angle with respect to the direction. For instance, U.S. Pat. No. 9,945,792, titled “GENERATING AN ARRAY OF SPOTS ON INCLINED SURFACES”; U.S. Patent Publication Number 20240310292, titled “OBLIQUE UNIFORM ILLUMINATION FOR IMAGING SYSTEMS”; are each incorporated herein by reference in the entirety. The beam-shaping channel 130 may include a focusing lens 512, and two cylindrical lenses 508, 510. The DOE 306 may include an FZP. By rotating, translating, and/or swapping the DOE 306 (e.g., FZP), a circular illumination beam will be shaped into a long and narrow spot array with all spots in focus at two or more different azimuthal angles.

In embodiments, the orthogonal pair of cylindrical lenses 508, 510 may be used to adjust the beam profile 308 to achieve better output beam quality.

In embodiments, the controller 122 is configured to direct one or more adjustments to the configuration the beam-shaping channel 130 to control the orientation of the beam profile 308.

For example, the controller 122 may be configured to direct at least one of a rotation, translation, or swapping of one or more cylindrical lenses 508, 510 of the beam-shaping channel 130.

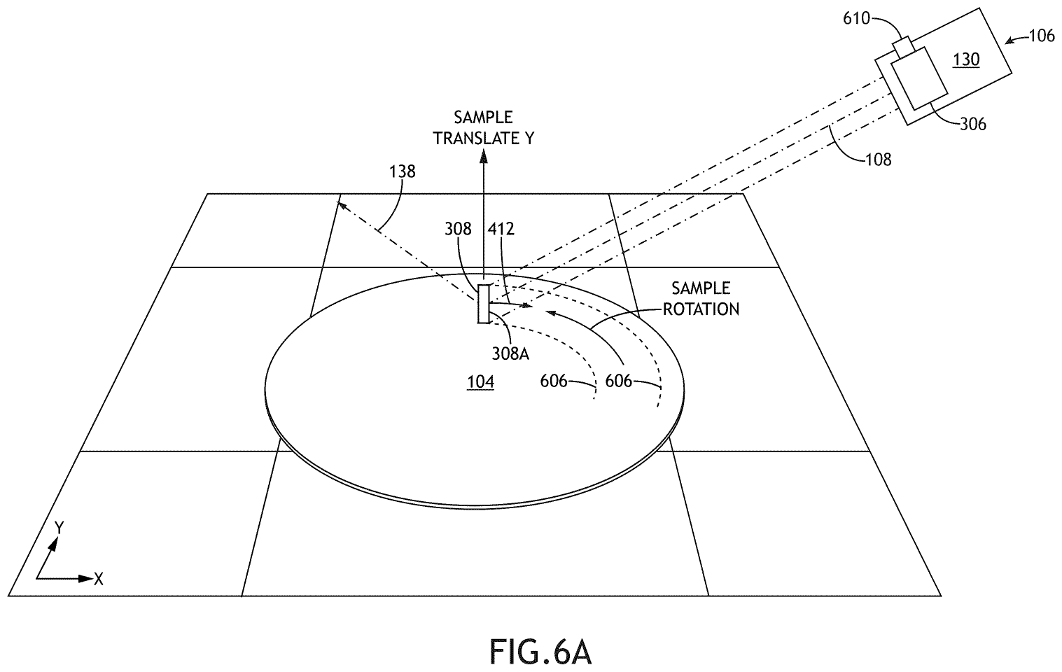

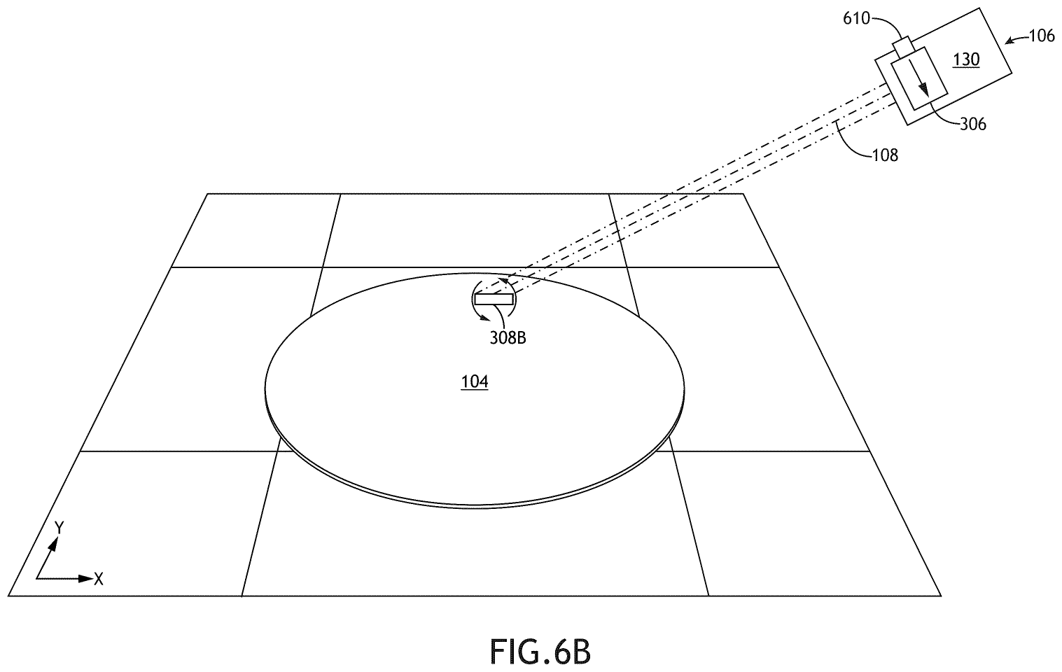

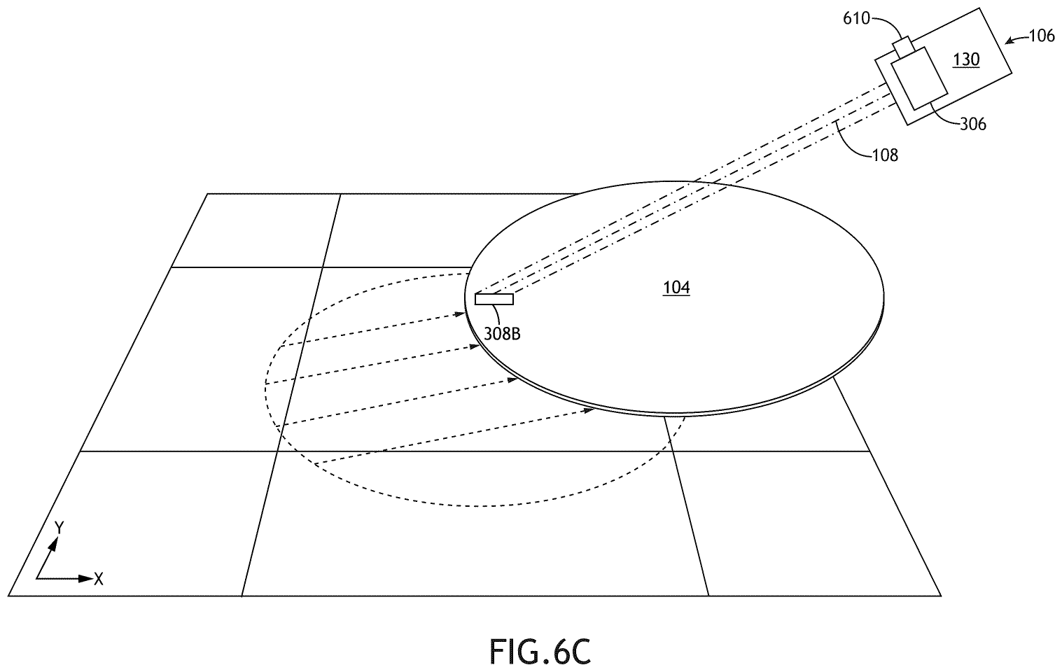

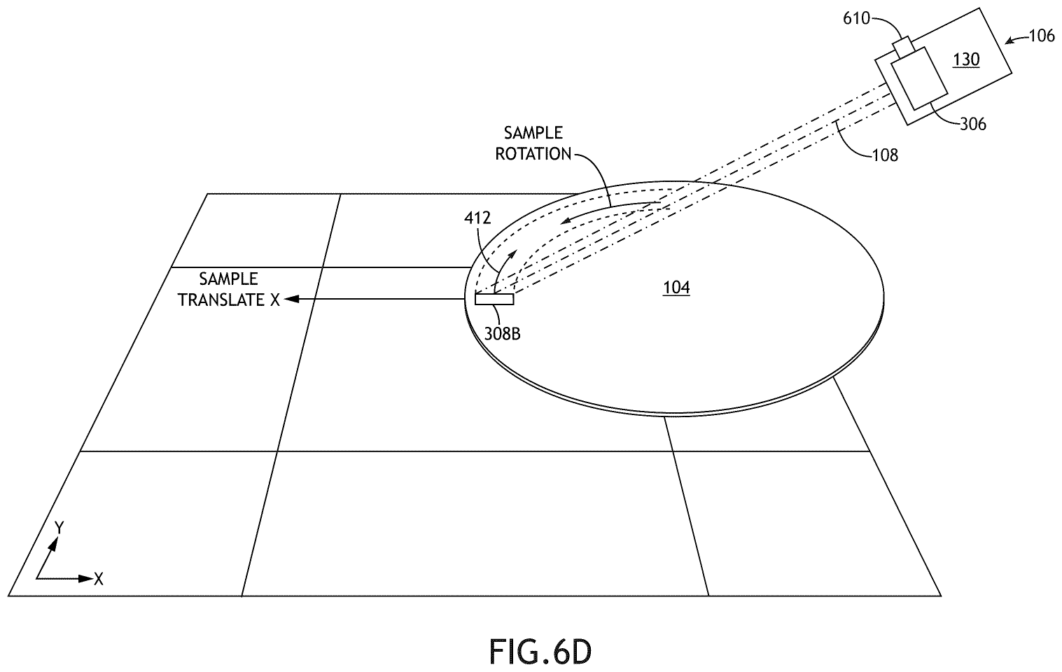

FIGS. 6A through 6D illustrate perspective views of scanning the sample 104 using two different orientations of the DOE 306 which correspond to two respective orientations of the beam profile 308 incident on the sample 104, in accordance with one or more embodiments of the present disclosure.

FIG. 6A illustrates a perspective view of a first scanning of the sample 104 using a first orientation of the DOE 306 of the beam-shaping channel 130, in accordance with one or more embodiments of the present disclosure.

In embodiments, the beam-shaping channel 130 includes a DOE 306 configured for rotation and/or translation about an axis of the illumination beam 108. Alternatively, and/or in addition, the DOE 306 may be configured to be swapped out. For example, the beam-shaping channel 130 may include one or more actuators 610 configured to control the configuration of one or more components of the beam-shaping channel 130. For example, the actuators 610 may be coupled to, and configured to rotate and/or translate, the DOE 306. In embodiments, controller 122 may transmit one or more control signals to the one or more actuators 610 to cause the one or more actuators 610 to actuate the DOE 306. In embodiments, the controller 122 may automatically transmit control signals to the actuators 610 based on program instructions stored on memory 126. For example, the controller 122 may be configured to control the actuation of the DOE 306 based on a scan sequence known a priori. For instance, the scan sequence may be configured to scan an entire surface of the sample 104 or a portion of the surface of the sample 104. For example, the controller 122 may be configured to control the rotation of the beam profile 308 in increments between each scan. For instance, the rotation may be 90 degrees between each scan. For instance, the rotation may be 45 degrees. Alternatively, the controller 122 may transmit control signals to the DOE 306 in response to instructions from a user via a user interface. For instance, the user may specify the number of scans and the azimuthal angle 304 for each scan.

The DOE 306 may include any diffractive optical element described herein or known in the art. The DOE 306 may include a Fresnel zone plate (FZP) offset from an axis of the illumination beam 108. The beam-shaping channel 130 may include a pair of orthogonal cylindrical lenses in front of the DOE 306 and configured to be used to adjust an aspect ratio and orientation of the illumination beam 108. The DOE 306 may include a holographic optical element (HOE). By way of another example, the DOE 306 may include a combination of two or more diffractive optical elements 306. For example, the beam-shaping channel 130 may include a diffractive optical element (DOE), a holographic optical element (HOE), and an aspherical lens. In another example, may include at least one of: a diffractive optical element (DOE), a holographic optical element (HOE), or an aspherical lens. In another example, the DOE 306 may include a DOE 306, a FZP, and a HOE. For instance, the DOE 306 may be a standard, non-FZP, non-HOE element.

The FZP may include concentric rings, known as Fresnel zones, which alternate between being opaque and transparent. This structure causes light to diffract around the opaque zones, focusing it at specific points. Alternatively, the FZP may be a phase-style FZP. HOEs may include various components such as holographic lenses, gratings, and filters. This holographic technology may be used to create specific interference and diffraction-based fringes.

The translation of the DOE 306 may include translating the illumination beam 108 to a different area of the DOE 306. For example, the DOE 306 may include two or more areas associated with two or more orientations of the beam profile 308. For instance, the DOE 306 may be translated along a direction to an adjacent, non-overlapping area/zone. For example, two or more DOE areas associated with different beam profile orientations may be effectively manufactured on a single DOE component or assembly such that the illumination beam 108 may be moved to the desired area associated with the desired orientation of the beam profile 308. For instance, four or more areas may be used for a horizontal, a vertical, and two diagonal orientations of the beam profile 308. In this way, a single DOE 306 may be used instead of swapping the DOE 306 out.

In embodiments, any scanning direction may be used. For example, the beam profile 308 may be aligned with a scanning direction 412. For example, a scanning boundary 606 may define the edges of a scan. For instance, the shape of the beam profile 308 may include an ellipse that is aligned with the scanning direction 412. Alternatively, the shape of the beam profile 308 may include a rectangle aligned with the scanning direction. In this way, the length of the rectangle may be configured to scan the widest possible path. By way of another example, the scanning direction 412 may be other directions as well. For instance, the scanning direction 412 may include at least one of: parallel to X-direction, parallel to Y-direction, or at 45 degrees relative to the X and Y directions. In such an example, the X and Y directions are defined as translation scanning directions, such as the translation directions of the stage 116.

In embodiments, the first configuration of the beam-shaping channel 130 controls an orientation of the beam profile 308 of the illumination beam 108 as projected onto the sample 104. For example, the first orientation of the DOE 306 may control and correspond to the first orientation 308A of the beam profile 308.

However, note that a different orientation of the DOE 306 is merely a nonlimiting example of a type of configuration of the beam-shaping channel 130 and is for illustrative purposes only, and any configuration of the beam-shaping channel 130 known in the art of characterization and inspection systems may be used. For instance, one or more actuations of one or more optical components of the single beam-shaping channel 130 may be used to control the orientation of the beam profile 308 on the sample 104.

FIG. 6B illustrates a perspective view of a second configuration of the beam-shaping channel 130. For example, the second configuration may be effectuated by a rotation, translation, and/or swapping of the DOE 306 to a second orientation causing a corresponding rotation of the beam profile 308 incident on the sample 104, in accordance with one or more embodiments of the present disclosure. The different orientation of the beam profile 308B may be referred to as a second orientation of the beam profile 308B.

FIG. 6C illustrates a translation of the sample 104 relative to the beam profile 308, in accordance with one or more embodiments of the present disclosure.

For example, the controller 122 may be configured to direct the stage 116 to realign the sample 104 with the scanning direction 412. For example, the sample 104 may be aligned for a scanning direction perpendicular to a length of the beam profile 308B. For instance, the beam profile 308B may be aligned such that the scan uses the full width of the beam profile 308B during the scan. For instance, the sample 104 may be moved so that a horizontal beam profile 308 is at a left or right edge of the sample 104, and aligned perpendicular to a direction tangential to the edge.

FIG. 6D illustrates a second scanning of the sample 104 using the second orientation of the beam profile 308 corresponding to the second orientation of the beam profile 308B, in accordance with one or more embodiments of the present disclosure.

For example, the sample 104 may be rotated and/or translated to perform the second scanning. For instance, as shown, the sample 104 may be translated in the X-direction while simultaneously rotated in the counterclockwise direction to effectuate a second spiral scan. Note that this scan pattern is nonlimiting and, alternatively, the sample 104 may be rotated in the clockwise direction.

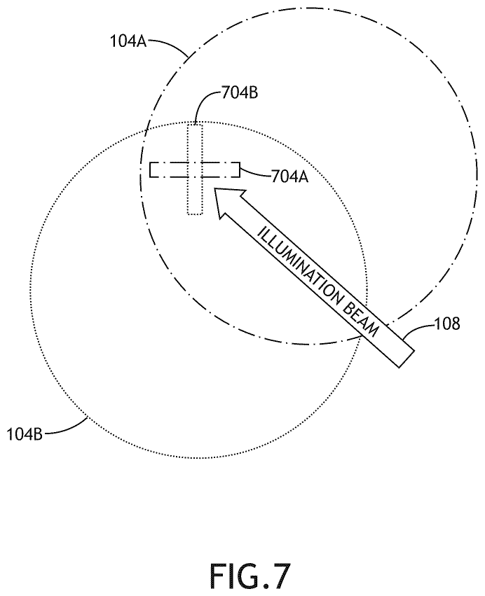

FIG. 7 illustrates a top view of various beam profile orientations 704A, 704B and corresponding translated sample locations 104A, 104B in accordance with one or more embodiments of the present disclosure.

As noted above, the sample 104 may be translated to align with each beam profile orientation for each scan. The controller 122 may be configured to use sample locations 104A, 104B with respective beam profile orientations 704A, 704B. For example, a vertical orientation 704B of the beam profile may be configured to be used with sample location 104B.

The sample positions shown are nonlimiting and used for illustrative purposes only. Any sample location may be used with any beam profile orientation, such as an edge-aligned and/or center-aligned beam profile position. For example, even though the horizontal beam profile orientation 704A is near a left edge of the sample, the horizontal beam profile 704A may alternatively be aligned with the right edge. Furthermore, the beam profile may be aligned with the center of the sample 104. In this way, spiral scans that are clockwise or counterclockwise may spiral from either edge of the sample. The spiral scans may start from the edge and move towards the center and/or start from the center and move towards the edge.

In embodiments, a shape of a field of view (FOV) of the detector 112 may be rectangular so that it may match the shape of the beam profile 308. However, when the beam profile orientation is rotated, the collectable light 138 incident on the detector 112 may not properly match the orientation of the FOV of the detector 112. In embodiments, a detection plane rotator may be used to maintain the orientation of collectable light 138 incident on the detector 112 as the beam profile 308 orientation is rotated.

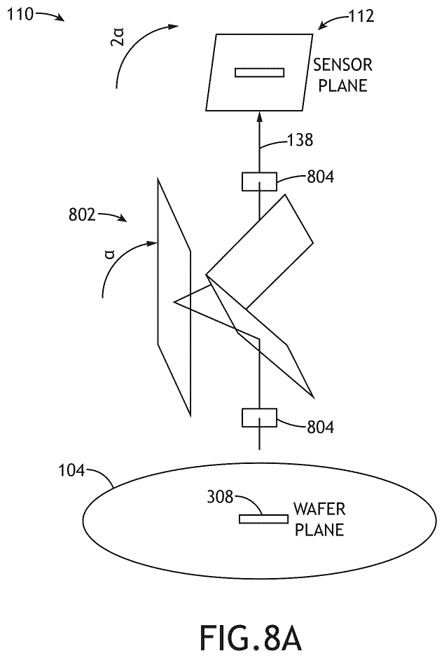

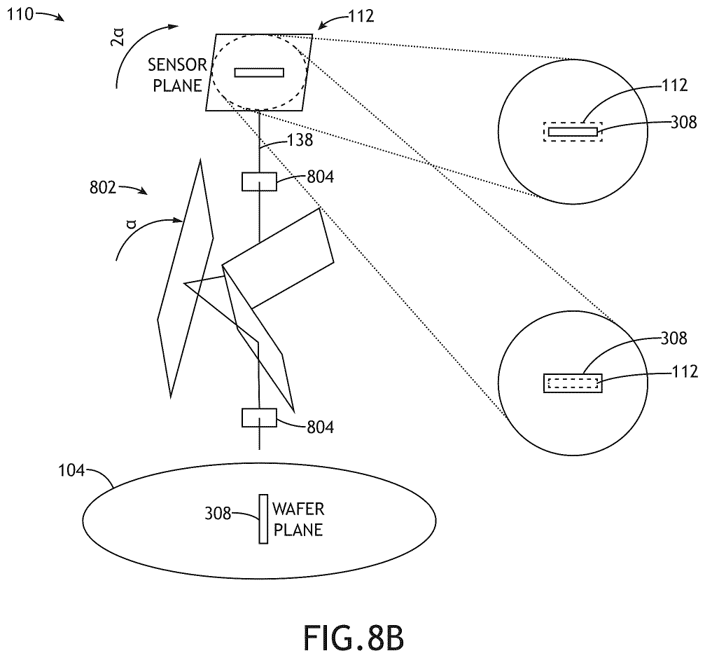

FIGS. 8A and 8B illustrate a side view of a K-mirror detection plane rotator 802 configured to perform a rotation corresponding to an orientation of collectable light 138 incident on the detector 112, in accordance with one or more embodiments of the present disclosure. In FIG. 8A, the orientation of the collectable light 138 emanating from the beam profile 308 on the sample 104 is already aligned and matches when it reaches a sensor plane of the detector 112. In FIG. 8B, the beam profile 308 is rotated 90 degrees. To prevent a misalignment of 90 degrees, a corresponding configuration of the detection plane rotator 802 is used to maintain a matching orientation of the collectable light 138 with the detector 112. For example, the controller 122 may be coupled to the detection plane rotator 802 and configured to control the configuration of the detection plane rotator 802 to match the orientation of the collectable light 138 with the FOV of the sensor plane of the detector 112. For instance, the controlling of the configuration of the detection plane rotator 802 may include any adjustment known in the art, such as rotating one or more surfaces (e.g., mirrors) of the K-mirror detection plane rotator 802 in a way that is configured to align the collectable light 138 with the sensor plane of the detector 112. Any structure may be used, such as actuators (not shown). In this manner, the orientation of the collectable light 138 may be matched with the detector 112 and stay consistent for all azimuthal angles 304. For example, defects on the sample 104 as shown in a sequence of scan data images may be configured to move from right to left, regardless of the azimuthal angle 304 being used.

However, note that an alternative option to achieve a similar result is to rotate the detector 112 itself. In embodiments, the rotation of the collectable light 138 may include at least one of a rotation of: 1) an orientation of collectable light 138 incident on the detector 112 performed before reaching the detector 112; or 2) an orientation of the detector 112 itself relative to the collectable light 138.

For instance, to rotate the detector 112, the detection plane rotator 802 may be coupled to, and configured to rotate the detector 112. For instance, the detection plane rotator 802 may include actuators (not shown) coupled to the detector 112.

To rotate the orientation of collectable light 138 incident on the detector 112, the detection plane rotator 802 may include any optical element known in the optical industry that is configured to rotate an orientation of the illumination beam 108. For example, the detection plane rotator 802 may include at least one of: a Dove Prism, a K-mirror, or a Schmidt-Pechan Prism. For instance, a K-mirror detection plane rotator 802 is shown and is configured to change an orientation of the collectable light 138 incident on the detector 112. The K-mirror detection plane rotator 802 may include a plurality of reflective elements, such as reflective elements arranged in the shape of the English letter “K.”

In embodiments, the inspection system 100 includes one or more optical elements 804 configured to illuminate and collect light from the sample 104 in any suitable fashion. The one or more optical elements 804 may include any optical elements known in the art of inspection systems. For example, the collection sub-system 110 may include optical elements 804 before and/or after the detection plane rotator 802. For instance, the optical elements 804 may include an objective lens below the detection plane rotator 802. Note that a simple representation is shown for purposes of simplicity and conciseness only and any number, type, and combination of optical elements 804 known in the art of inspection systems may be used.

In embodiments, a size of a field of view (FOV) of the detector 112 may be configured to be smaller than, equal to, or larger than a size of the collectable light 138 corresponding to the beam profile 308 as projected onto the detector 112. In this manner, the FOV may be used to image the entire beam profile 308 and/or, alternatively, for the beam profile 308 to entirely fill the FOV of the detector 112.

The optical elements 804, such as optical elements of the collection sub-system 110, may be configured to magnify and/or de-magnify the collectable light 138 as projected onto the detector 112. For example, the size of the collectable light 138 may be controlled so that a more efficient use of the entire FOV may be used.

Referring again to FIG. 2, various components are described in greater detail in accordance with one or more embodiments of the present disclosure.

The one or more processors 124 of the controller 122 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 124 may include any device configured to execute algorithms and/or instructions (e.g., program instructions stored in memory). In embodiments, the one or more processors 124 may be embodied as a desktop computer, mainframe computer system, workstation, image computer, parallel processor, networked computer, or any other computer system configured to execute a program configured to operate or operate in conjunction with the inspection system 100, as described throughout the present disclosure. Moreover, different subsystems of the inspection system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller or, alternatively, multiple controllers. Additionally, the controller 122 may include one or more controllers housed in a common housing or within multiple housings. In this way, any controller or combination of controllers may be separately packaged as a module suitable for integration into inspection system 100. Further, the controller 122 may analyze or otherwise process data received from one or more sensors and feed the data to additional components within the inspection system 100 or external to the inspection system 100.

Further, the memory 126 may include any storage medium known in the art suitable for storing program instructions executable by the associated one or more processors 124. For example, the memory 126 may include a non-transitory memory medium. As an additional example, the memory 126 may include, but is not limited to, a read-only memory, a random-access memory, a magnetic or optical memory device (e.g., disk), a magnetic tape, a solid-state drive and the like. It is further noted that memory 126 may be housed in a common controller housing with the one or more processors 124.

In this regard, the controller 122 may execute any of various processing steps associated with optical inspection. For example, the controller 122 may be configured to generate control signals to direct or otherwise control the optical sub-system 102, or any components thereof. For instance, the controller 122 may be configured to receive signals (e.g., scan data) corresponding to the images from the optical sub-system 102. By way of another example, the controller 122 may generate correctables for one or more additional fabrication tools as feedback and/or feed-forward control of the one or more additional fabrication tools based on measurements from the optical sub-system 102.

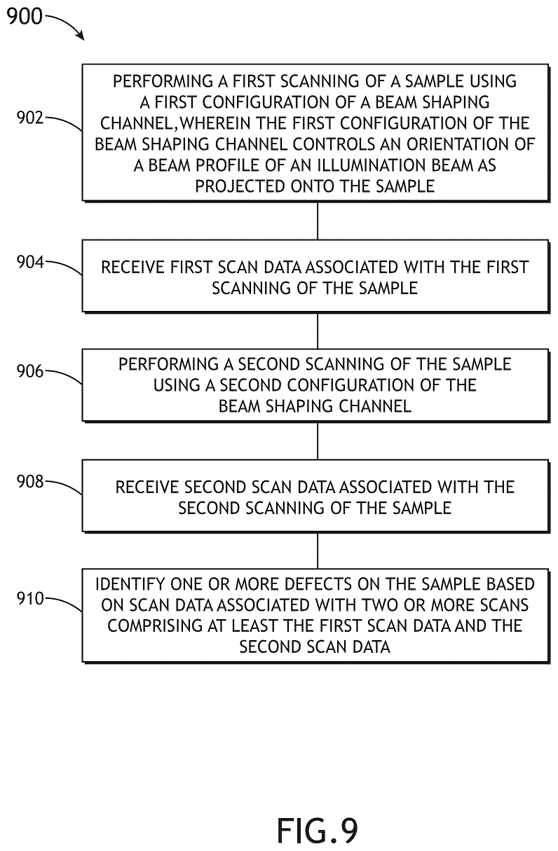

FIG. 9 illustrates a process flow diagram depicting a method 900 for inspecting the sample 104 using the plurality of azimuthal angles 304 and the beam-shaping channel 130, in accordance with one or more embodiments of the present disclosure. It is noted that the embodiments and enabling technologies described previously herein in the context of the inspection system 100 should be interpreted to extend to the method 900. It is further noted herein that the steps of method 900 may be implemented all or in part by inspection system 100. It is further recognized, however, that the method 900 is not limited to the inspection system 100 in that additional or alternative system-level embodiments may carry out all or part of the steps of method 900.

A step 902 includes directing the first scanning of the sample 104 using a first configuration of the beam-shaping channel 130. For example, the first configuration may include the first orientation of the DOE 306. For example, the controller 122 may be configured to direct the first scanning of the sample 104. For instance, the controller 122 may be communicatively coupled to the stage 116 and the one or more detectors 112 and configured to direct those components to perform the first scan. For instance, the controller 122 may direct signals configured to rotate the sample 104 using the stage 116 and simultaneously receive scan data using the one or more detectors 112.

At an optional step, such as a step between scans or before step 902, control signals are generated for the beam-shaping channel 130 to configure the beam-shaping channel 130 to provide one or more selected orientations of the beam profile 308. For instance, controller 122 may be configured to determine, and/or direct a transmission of control signals to one or more components configured to use the control signals. For instance, the control signals may be configured to control the actuators 610 or other active components of the beam-shaping channel 130. For instance, the control signals may be configured to automatically rotate the beam profile 308 to a select first orientation before the first scanning of the sample 104.

At a step 904, first scan data associated with the first scanning of the sample 104 is received. For example, the first scan data may be acquired by the controller 122 based on the signals detected by the one or more detectors 112.

At an optional step, the beam-shaping channel 130 is actively (e.g., using actuators) or manually (e.g., by a human user) set to a second configuration. The second configuration of the beam-shaping channel 130 is associated with a second orientation of the beam profile 308. The configuration of the beam-shaping channel 130 may deterministically control the orientation of the beam profile 308. For example, the DOE 306 may be rotated to a second orientation. For instance, FIG. 6B illustrates the DOE 306 being rotated to the second orientation. The controller 122 may be configured to direct actuators 610 based on control signals, to control the orientation of the DOE. By way of another example, the DOE 306 may be configured to be manually rotated by a user between scans. By way of another example, the DOE 306 may be swapped out with another DOE 306.

At an optional step, the sample 104 may be translated by the stage 116 to align the orientation of the sample 104 with the second orientation of the beam profile 308.

At an optional step, a determination may be performed between scans to determine whether additional scan data is needed, including after the first scan, and thereby whether to perform any additional scans. For example, the first scan data may be sufficient to identify defects and so no additional scans may be needed. In this manner, the inspection system 100 may be configured to stop scanning after any particular scan. Note that this is a nonlimiting example only, and the inspection system 100 does not necessarily need to determine whether to perform additional scans.

A step 906 includes directing a second scanning of the sample 104 using a second configuration of the beam-shaping channel 130.

For instance, the controller 122 may be configured to sense the configuration of the beam-shaping channel 130 and perform the second scanning of the sample 104 pursuant to a sensed, controlled, or known configuration of the beam-shaping channel 130. For instance, the controller 122 may be configured to align the scanning direction 412 such that the scanning direction 412 is aligned with the beam profile 308.

At a step 908, second scan data associated with the second scanning of the sample 104 is received. For example, the second scan data may be acquired by the controller 122 based on signals detected by the one or more detectors 112.

At a step 910, one or more defects on the sample 104 are identified based on scan data associated with two or more scans of the sample 104. For example, the one or more defects may be based on at least the first scan data and the second scan data. For instance, the first scan data and the second scan data may be aggregated to identify one or more defects on the sample 104. The identification of defects may include any defect identification methodology known in the art of inspection systems.

In embodiments, any number of scans and scan data may be used. For example, the scan data from the two or more scans may include a third scan data associated with a third scanning (e.g., diagonal scanning) of the sample 104. For example, the scan data from the two or more scans may include a fourth scan data associated with a fourth scanning (e.g., an orthogonal diagonal scanning) of the sample 104.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The previous description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the inspection systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

We claim:

1. An inspection system for inspecting using a plurality of azimuthal angles comprising:
a controller configured to be communicatively coupled to an optical sub-system and comprising one or more processors configured to execute program instructions causing the one or more processors to:
generate control signals for a beam-shaping channel to configure the beam-shaping channel to provide one or more selected orientations of a beam profile of an illumination beam as projected onto the sample;
direct a stage to perform one or more scans comprising a first scanning of the sample using a first configuration of the beam-shaping channel, wherein the first configuration of the beam-shaping channel is based on the control signals and controls an orientation of the beam profile of the illumination beam as projected onto the sample, wherein the first configuration is associated with a first orientation of the beam profile of the illumination beam as projected onto the sample;
receive first scan data associated with the first scanning of the sample; and
identify one or more defects on the sample based on scan data associated with the one or more scans comprising at least the first scan data.

2. The inspection system of claim 1, wherein the first configuration of the beam-shaping channel includes a first orientation of a diffractive optical element of the beam-shaping channel, wherein the diffractive optical element is configured to be rotated around an axis of the illumination beam, wherein the first orientation of the diffractive optical element controls the orientation of the beam profile of the illumination beam as projected onto the sample.

3. The inspection system of claim 2, wherein the controller is further configured to direct a rotation of the diffractive optical element around the axis of the illumination beam from the first orientation to a second orientation.

4. The inspection system of claim 2, wherein the controller is further configured to direct a translation of the diffractive optical element from the first orientation to a second orientation.

5. The inspection system of claim 2, wherein the diffractive optical element comprises a Fresnel zone plate (FZP) offset from the axis of the illumination beam.

6. The inspection system of claim 2, wherein the beam-shaping channel further comprises a holographic optical element (HOE), and an aspherical lens.

7. The inspection system of claim 1, wherein the controller is further configured to direct at least one of a rotation or translation of one or more cylindrical lenses of the beam-shaping channel.

8. The inspection system of claim 1, wherein the inspection system further comprises a collection sub-system, wherein the collection sub-system comprises:
a detector; and
a detection plane rotator configured to perform a rotation of collectable light as detected by the detector, wherein the rotation of the collectable light comprises at least one of a rotation of: an orientation of the collectable light incident on the detector; or an orientation of the detector.

9. The inspection system of claim 8, wherein the controller is further configured to:
direct the detection plane rotator to perform the rotation of the collectable light.

10. The inspection system of claim 9, wherein the detection plane rotator comprises as least one of: a Dove Prism, a K-mirror, or a Schmidt-Pechan Prism.

11. The inspection system of claim 1, wherein the beam profile comprises a flat top profile such that an intensity distribution is uniform.

12. The inspection system of claim 1, wherein the beam profile comprises a spot array, wherein the spot array comprises a series of ellipses sequentially aligned in a row along a direction and wherein a major axis of each ellipse is angled at a non-zero angle with respect to the direction.

13. The inspection system of claim 1, wherein the scan data from the one or more scans further comprises a second scan data associated with a second scanning of the sample.

14. The inspection system of claim 13, wherein the scan data from the one or more scans further comprises a third scan data associated with a third scanning of the sample.

15. The inspection system of claim 1, wherein the stage comprises an X-Y θ stage configured to translate the sample in two orthogonal directions and rotate the sample.

16. The inspection system of claim 15, wherein the controller is further configured to direct the X-Y θ stage to at least translate the sample between the first scanning and a second scanning.

17. The inspection system of claim 16, wherein the controller is further configured to:
direct the X-Y θ stage to simultaneously rotate the sample and translate the sample along two directions during the first scanning, wherein the first scanning is configured along a spiral scan pattern.

18. An inspection system for inspecting using a plurality of azimuthal angles comprising:
a stage configured to translate and rotate a sample;
an optical sub-system comprising:
an illumination sub-system comprising a beam-shaping channel, wherein a configuration of the beam-shaping channel controls an orientation of a beam profile of an illumination beam as projected onto the sample; and
a collection sub-system comprising a detector configured to image the sample; and
a controller communicatively coupled to the optical sub-system and comprising one or more processors configured to execute program instructions causing the one or more processors to:
receive first scan data associated with a first orientation of the beam profile of the illumination beam as projected onto the sample and associated with a first scanning of the sample using a first configuration of the beam-shaping channel;
receive second scan data associated with a second orientation of the beam profile of the illumination beam as projected onto the sample and associated with a second scanning of the sample using a second configuration of the beam-shaping channel; and
identify one or more defects on the sample based on scan data associated with two or more scans comprising at least the first scan data and the second scan data.

19. The inspection system of claim 18, wherein the first configuration of the beam-shaping channel includes a first orientation of a diffractive optical element of the beam-shaping channel, wherein the diffractive optical element is configured to be rotated around an axis of the illumination beam, wherein the first orientation of the diffractive optical element controls the orientation of the beam profile of the illumination beam as projected onto the sample.

20. The inspection system of claim 19, wherein the controller is further configured to direct a rotation of the diffractive optical element around the axis of the illumination beam from the first orientation to a second orientation.

21. The inspection system of claim 19, wherein the controller is further configured to direct a translation of the diffractive optical element from the first orientation to a second orientation.

22. The inspection system of claim 19, wherein the diffractive optical element comprises a Fresnel zone plate (FZP) offset from the axis of the illumination beam.

23. The inspection system of claim 19, wherein the beam-shaping channel further comprises a holographic optical element (HOE), and an aspherical lens.

24. The inspection system of claim 18, wherein the collection sub-system further comprises a detection plane rotator configured to perform a rotation of collectable light as detected by the detector, wherein the rotation of the collectable light comprises at least one of a rotation of: an orientation of the collectable light incident on the detector; or an orientation of the detector.

25. The inspection system of claim 24, wherein the controller is further configured to:
direct the detection plane rotator to perform the rotation of the collectable light.

26. The inspection system of claim 25, wherein the detection plane rotator comprises as least one of: a Dove Prism, a K-mirror, or a Schmidt-Pechan Prism.

27. The inspection system of claim 18, wherein the beam profile comprises a rectangular shape having a flat top profile.

28. The inspection system of claim 18, wherein the beam profile comprises a spot array, wherein the spot array comprises a series of ellipses sequentially aligned in a row along a direction and wherein a major axis of each ellipse is angled at a non-zero angle with respect to the direction.

29. The inspection system of claim 18, wherein the scan data from the two or more scans further comprises a third scan data associated with a third scanning of the sample.

30. The inspection system of claim 29, wherein the scan data from the two or more scans further comprises a fourth scan data associated with a fourth scanning of the sample.

31. The inspection system of claim 18, wherein the stage comprises an X-Y θ stage configured to translate the sample in two orthogonal directions and rotate the sample.

32. The inspection system of claim 31, wherein the controller is further configured to direct the X-Y θ stage to at least translate the sample between the first scanning and the second scanning.

33. The inspection system of claim 32, wherein the controller is further configured to:
direct the X-Y θ stage to simultaneously rotate the sample and translate the sample along two directions during the first scanning, wherein the first scanning is configured along a spiral scan pattern.

34. A method for inspecting using a plurality of azimuthal angles comprising:
performing a first scanning of a sample using a first configuration of a beam-shaping channel of an optical sub-system, wherein the first configuration of the beam-shaping channel controls an orientation of a beam profile of an illumination beam as projected onto the sample;
receiving first scan data associated with the first scanning of the sample;
performing a second scanning of the sample using a second configuration of the beam-shaping channel, wherein the second configuration corresponds to a second orientation of the beam profile of the illumination beam as projected onto the sample;
receiving second scan data associated with the second scanning of the sample; and
identifying one or more defects on the sample based on scan data associated with two or more scans comprising at least the first scan data and the second scan data.

35. The method of claim 34, wherein the first configuration of the beam-shaping channel includes a first orientation of a diffractive optical element, wherein the diffractive optical element is configured to be rotated around an axis of the illumination beam, wherein the first orientation of the diffractive optical element controls the orientation of the beam profile of the illumination beam as projected onto the sample.

36. The method of claim 35, further comprising rotating the diffractive optical element around the axis of the illumination beam from the first orientation to the second orientation.

37. The method of claim 34, wherein the scan data from the two or more scans further comprises a third scan data associated with a third scanning of the sample.

38. The method of claim 37, wherein the scan data from the two or more scans further comprises a fourth scan data associated with a fourth scanning of the sample.

39. The method of claim 34, wherein a stage used in the first scanning and the second scanning comprises an X-Y θ stage configured to translate the sample in two orthogonal directions and rotate the sample.

40. The method of claim 39, further comprising directing the X-Y θ stage to at least translate the sample between the first scanning and the second scanning.

41. The method of claim 40, further comprising:
directing the X-Y θ stage to simultaneously rotate the sample and translate the sample along two directions during the first scanning, wherein the first scanning is configured along a spiral scan pattern.
